(19) United States
(12) Patent Application Publication
(10) Pub. No.: US 2025/0296169 A1
(43) Pub. Date: Sep. 25, 2025

(54) Welding System

(71) Applicants: Measurement Specialties (Chengdu) Ltd, Chengdu (CN); Tyco Electronics (Shanghai) Co., Ltd., Shanghai (CN)

(72) Inventors: Yang Li, Shanghai (CN); Fengchun (Fred) Xie, Shanghai (CN); Huabin Du, Shanghai (CN); Yong (Bill) Wang, Shanghai (CN); Ping Huang, Chengdu (CN)

(73) Assignees: Measurement Specialties (Chengdu) Ltd, Chengdu (CN); Tyco Electronics (Shanghai) Co., Ltd., Shanghai (CN)

(21) Appl. No.: 19/083,526

(22) Filed: Mar. 19, 2025

(30) Foreign Application Priority Data
Mar. 19, 2024 (CN) 202410316086.2

(51) Int. Cl. B23K 3/06; B23K 1/00; B23K 3/04; B23K 3/08; B23K 31/12; B23K 101/32; B23K 101/38

(52) U.S. Cl. CPC B23K 3/0638; B23K 1/0008; B23K 3/04; B23K 3/087; B23K 31/125; B23K 2101/32; B23K 2101/38

(57) ABSTRACT

A welding system for welding a pair of micro wires of an electronic device together includes a solder paste distribution unit. The solder paste distribution unit has a carrier loading and fixing the electronic device, a solder paste dispenser spraying a solder paste outward, a visual device identifying a position of the pair of micro wires and a space between the pair of micro wires, a planning device pre-planning a starting position, an ending position, and a distribution path of the solder paste based on the position and the space of the pair of micro wires recognized by the visual device. A moving device moves the solder paste dispenser at a predetermined speed according to the starting position, the ending position, and the distribution path to distribute the solder paste to a plurality of predetermined locations of the pair of micro wires.

### CROSS-REFERENCE TO RELATED APPLICATION

This application claims the benefit of the filing date under 35 U.S.C. § 119 (a)-(d) of Chinese Patent Application No. CN202410316086.2, filed on Mar. 19, 2024.

### FIELD OF THE INVENTION

The present invention relates to a welding system, particularly to a welding system for welding a pair of micro wires of an electronic device together.

### BACKGROUND OF THE INVENTION

A micro thermocouple has a pair of exposed parallel micro wires, and the ends of the parallel micro wires need to be welded together. In order to ensure reliable electrical connection and product durability, a solder joint must present a uniform distribution of solder on the wire, without visible gaps or residual flux, and its dimension must be within the specified tolerance range. However, considering the small size of the product and the lack of precise control, achieving these requirements is a major challenge. Although the existing manual process is stable, it requires a significant input of skilled labor. There have been attempts to automate this process, but none have achieved the desired outcome. Although visual algorithms have been implemented, their practicality is limited to inspection rather than guidance, thus making no significant contribution to product quality.

### SUMMARY OF THE INVENTION

A welding system for welding a pair of micro wires of an electronic device together includes a solder paste distribution unit. The solder paste distribution unit has a carrier loading and fixing the electronic device, a solder paste dispenser spraying a solder paste outward, a visual device identifying a position of the pair of micro wires and a space between the pair of micro wires, a planning device pre-planning a starting position, an ending position, and a distribution path of the solder paste based on the position and the space of the pair of micro wires recognized by the visual device. A moving device moves the solder paste dispenser at a predetermined speed according to the starting position, the ending position, and the distribution path to distribute the solder paste to a plurality of predetermined locations of the pair of micro wires.

### BRIEF DESCRIPTION OF THE DRAWINGS

The invention will now be described by way of example with reference to the accompanying figures, of which:

FIG. 1 shows an illustrative view of a solder paste distribution unit of a welding system according to an exemplary embodiment of the present invention;

FIG. 2 shows an illustrative view of the heating and melting unit of a welding system according to an exemplary embodiment of the present invention; and

FIG. 3 shows an illustrative view of a welding quality inspection unit of a welding system according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

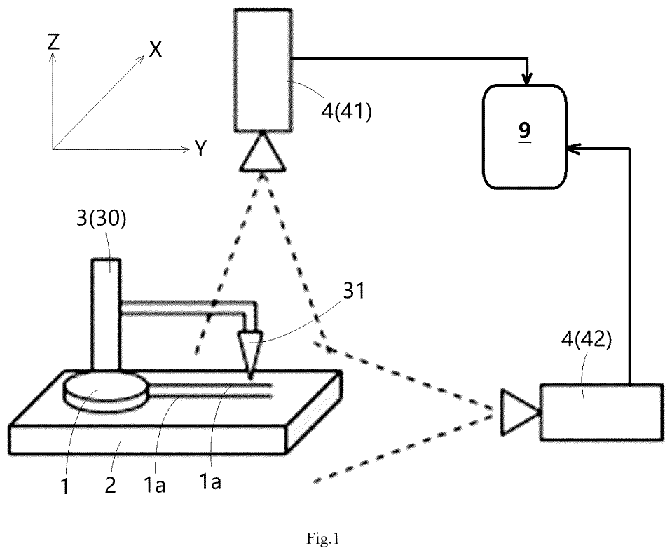

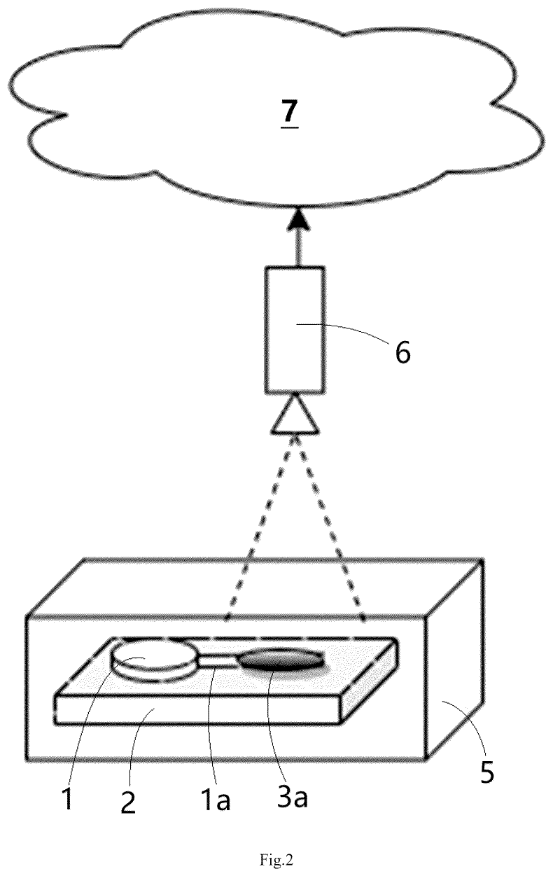

As shown in FIGS. 1 to 3, in an exemplary embodiment of the present invention, a welding system is disclosed. This welding system is used to weld a pair of micro wires 1a of an electronic device 1 together. For example, the welding system can be used to weld the ends of a pair of parallel micro wires exposed from a thermocouple together.

As shown in FIGS. 1 to 3, in the illustrated embodiment, the welding system includes a solder paste distribution unit. The solder paste distribution unit includes: a carrier 2, a solder paste dispenser 3, a visual device 4, a planning device 9, and a moving device. The carrier 2 is used to load and secure the electronic device 1. The solder paste dispenser 3 is used to spray solder paste 3a outward. The visual device 4 is used to identify the position and space between the pair of micro wires 1a. The planning device 9 pre-plans the starting position, ending position, and distribution path of solder paste distribution based on the position and space recognized by the visual device 4. The moving device moves the solder paste dispenser 3 at a predetermined speed according to the planned start position, end position, and distribution path to distribute the solder paste 3a to the predetermined locations of the pair of micro wires 1a, for example, to the ends of the pair of micro wires 1a.

As shown in FIGS. 1 to 3, in the illustrated embodiment, the solder paste dispenser 3 includes a container 30, a nozzle 31, and a controller. The container 30 is used to contain and supply solder paste 3a. The nozzle 31 is installed on container 30 for spraying solder paste 3a outward. The controller is used to control the opening and closing of the nozzle 31 and the solder paste spraying rate. The solder paste dispenser 3 also includes a monitoring device for monitoring the amount of solder paste in the container 3. When the monitoring device detects that the solder paste in the container 3 is almost used up, it will issue an alarm to remind timely replenishment of solder paste.

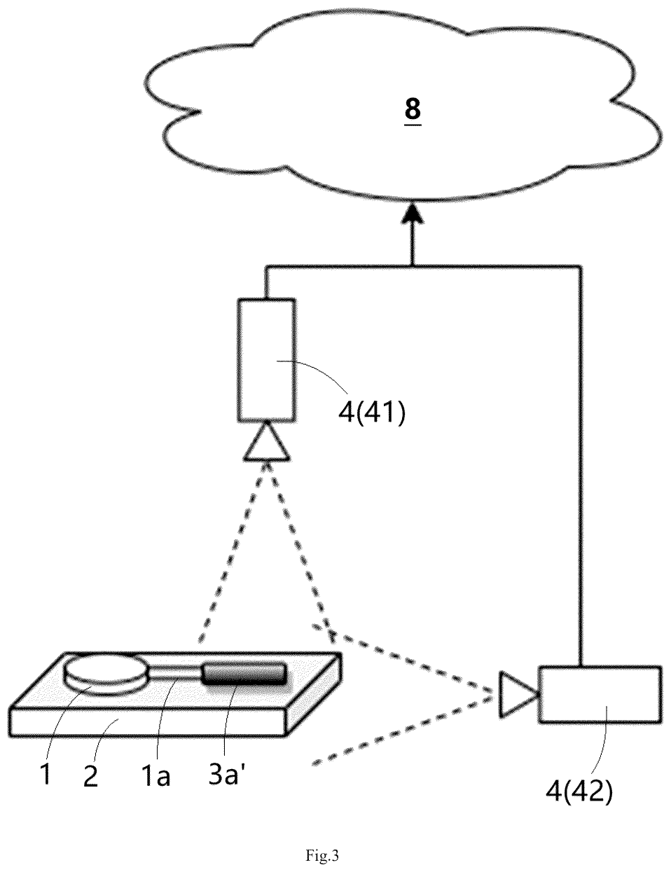

As shown in FIGS. 1 and 3, in the illustrated embodiment, the visual device 4 includes a first camera 41 and a second camera 42. The first camera 41 and the second camera 42 can be color cameras. The first camera 41 is located above the pair of micro wires 1a and is used to capture images of the pair of micro wires 1a in a vertical direction perpendicular to the axial direction of the pair of micro wires 1a. The second camera 42 is located in front of the end of a pair of micro wires 1a and is used to capture images of the pair of micro wires 1a along a horizontal direction parallel to the axial direction of the pair of micro wires 1a. Before distributing the solder paste, the first camera 41 and the second camera 42 capture a set of first images, and the visual device 4 recognizes the position and space between the pair of micro wires 1a based on the captured set of first images.

As shown in FIG. 1, in the illustrated embodiment, the pair of micro wires 1a extend along the first horizontal direction Y and are spaced opposite each other in the second horizontal direction X perpendicular to the first horizontal direction Y. The moving device is suitable for moving the solder paste dispenser 3 along the first horizontal direction Y, the second horizontal direction X, and the vertical direction Z perpendicular to the horizontal direction.

In an exemplary embodiment of the present invention, the moving device may be a translation mechanism capable of moving along the first horizontal direction Y, the second horizontal direction X, and the vertical direction Z. The solder paste dispenser 3 is installed on the translation mechanism to be able to move along the first horizontal direction Y, the second horizontal direction X, and the vertical direction Z together with the translation mechanism. In another exemplary embodiment of the present invention, the moving device may be a multi axis robot with multiple degrees of freedom, which can grasp the solder paste dispenser 3 and move it along the first horizontal direction Y, the second horizontal direction X, and the vertical direction Z.

After dispensing the solder paste, the solder paste dispenser 3 is moved out of the field of view of the first camera 41 and the second camera 42, then the first camera 41 and the second camera 42 capture a set of second images. The solder paste distribution unit also includes a solder paste distribution quality detection device, which determines whether the solder paste distribution quality is qualified based on a set of second images captured.

As shown in FIGS. 1 to 3, in the illustrated embodiment, the welding system also includes a heating and melting unit. The heating and melting unit includes a heating device 5, a temperature detection device 6, and a heating control device 7. The heating device 5 is used to heat the solder paste 3a that has been distributed onto the pair of micro wires 1a, in order to melt the solder in the solder paste 3a. The temperature detection device 6 is used to detect the temperature of the solder paste 3a and the ambient temperature around the solder paste 3a. The heating control device 7 controls the heating temperature and heating time of the solder paste 3a based on the temperature of the solder paste and the ambient temperature detected by the temperature detection device 6, until the solder in the solder paste 3a is completely melted.

In an embodiment, the heating and melting unit further comprises a handling device for moving the carrier 2 loaded with the electronic device 1 to the heating zone of the heating device 5 to heat the solder paste 3a distributed on the pair of micro wires 1a of the electronic device 1.

When the distribution quality of solder paste 3a on the pair of micro wires 1a is qualified, the heating control device 7 controls the handling device to move the carrier 2 to the heating zone of the heating device 5. In an exemplary embodiment of the present invention, the handling device may be a translation device capable of moving in three different directions perpendicular to each other, and the carrier 2 is mounted on the translation device to be able to move along the three different directions together with the translation device. In another exemplary embodiment of the present invention, the handling device may be a mechanical arm with multiple degrees of freedom, which can grasp the carrier 2 and move the carrier 2 in three different directions perpendicular to each other.

In an embodiment, the temperature detection device 6 includes an infrared camera that points towards the solder paste 3a on the pair of micro wires 1a to capture thermal images of the solder paste 3a and its surrounding environment.

In an embodiment, the heating control device 7 includes an artificial intelligence control network, which determines the heating temperature and heating time of the solder paste 3a based on the thermal images captured by the infrared camera. The artificial intelligence control network can determine whether the solder in solder paste 3a has been completely melted based on the thermal images captured by the infrared camera. When the artificial intelligence control network determines that the solder in the solder paste 3a has been completely melted, the artificial intelligence control network controls the handling device to remove the carrier 2 from the heating device 5 to stop heating the solder paste 3a.

As shown in FIGS. 1 to 3, in the illustrated embodiment, the welding system also includes a welding quality inspection unit. This welding quality inspection unit is used to check whether the welding quality of the cured solder joint 3a′ on the pair of micro wires 1a removed from the heating device 5 is qualified. The welding quality inspection unit includes the aforementioned visual device 4 and a welding quality judgment device. The visual device 4 includes the aforementioned first camera 41 and the aforementioned second camera 42. The welding quality inspection unit and the solder paste distribution unit share the first camera 41 and the second camera 42, which can reduce costs. In the illustrated embodiment, the first camera 41 is located above the pair of micro wires 1a and is used to capture images of the solder joint 3a′ on the pair of micro wires 1a in a vertical direction perpendicular to the axial direction of the pair of micro wires 1a. The second camera 42 is located in front of the ends of the pair of micro wires 1a, and is used to capture images of the solder joint 3a′ on the pair of micro wires 1a along a horizontal direction parallel to the axial direction of the pair of micro wires 1a. The welding quality judgment device determines whether the welding quality of welding joint 3a′ is qualified based on the captured images of welding joint 3a′.

In an embodiment, the welding quality judgment device includes an artificial intelligence inspection network. The artificial intelligence inspection network extracts welding joint features from the captured images of welding joint 3a′ and compares the extracted welding joint features with the pre learned welding joint features. When the similarity between the extracted solder joint features and the learned solder joint features is greater than a predetermined value, the artificial intelligence inspection network determines that the welding quality of solder joint 3a′ is qualified.

The present application discloses a new micro parallel wires welding process guided by artificial intelligence and vision. This automated welding process utilizes multiple technologies to ensure accuracy in application. Initially, a set of cameras 41, 42 guide the moving device to accurately distribute solder paste between two wires 1a. Subsequently, the handling device positions the carrier 2 and the exposed wires 1a into the heating zone. Throughout the entire heating process, an AI driven thermal imaging system observes in real-time to determine the optimal heating temperature and duration. After completion, the cured solder joint is comprehensively inspected by an AI enhanced camera to confirm their quality.

In the aforementioned exemplary embodiments according to the present invention, the solder paste distribution unit of the welding system can achieve precise dispensing of solder paste, improve the quality of solder paste dispensing, and thus enhance the soldering quality of the pair of micro wires of the electronic device.

In addition, in the aforementioned exemplary embodiments of the present invention, the heating and melting unit of the welding system can accurately control the heating temperature and heating time, thereby further improving the welding quality of the pair of micro wires of the electronic device.

In addition, in the aforementioned exemplary embodiments of the present invention, the welding quality inspection unit of the welding system adopts artificial intelligence to evaluate the quality of welding joint, improving the reliability and consistency of welding joint quality detection.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A welding system for welding a pair of micro wires of an electronic device together, comprising:
a solder paste distribution unit, including:
a carrier loading and fixing the electronic device;
a solder paste dispenser spraying a solder paste outward;
a visual device identifying a position of the pair of micro wires and a space between the pair of micro wires;
a planning device pre-planning a starting position, an ending position, and a distribution path of the solder paste based on the position and the space of the pair of micro wires recognized by the visual device; and
a moving device moving the solder paste dispenser at a predetermined speed according to the starting position, the ending position, and the distribution path to distribute the solder paste to a plurality of predetermined locations of the pair of micro wires.

2. The welding system according to claim 1, wherein the solder paste dispenser includes:
a container containing the solder paste;
a nozzle installed on the container and spraying the solder paste outward; and
a controller controlling an opening and closing of the nozzle and a spraying rate of the solder paste.

3. The welding system according to claim 1, wherein the visual device includes:
a first camera located above the pair of micro wires and capturing a plurality of images of the pair of micro wires in a vertical direction perpendicular to an axial direction of the pair of micro wires; and
a second camera located in front of a pair of ends of the pair of micro wires and capturing a plurality of images of the pair of micro wires along a horizontal direction parallel to the axial direction of the pair of micro wires, the first camera and the second camera capture a set of first images and the visual device recognizes the position and the space between the pair of micro wires based on the captured set of first images before distributing the solder paste.

4. The welding system according to claim 1, wherein the pair of micro wires extend along a first horizontal direction and are spaced apart in a second horizontal direction perpendicular to the first horizontal direction, the moving device moves the solder paste dispenser along the first horizontal direction, the second horizontal direction, and a vertical direction perpendicular to the first horizontal direction and the second horizontal direction.

5. The welding system according to claim 4, wherein the moving device is a translation mechanism capable of moving along the first horizontal direction, the second horizontal direction, and the vertical direction, the solder paste dispenser is installed on the translation mechanism to be able to move along the first horizontal direction, the second horizontal direction, and the vertical direction with the translation mechanism.

6. The welding system according to claim 4, wherein the moving device is a multi-axis robot with a plurality of degrees of freedom, which can grasp the solder paste dispenser and move it along the first horizontal direction, the second horizontal direction, and the vertical direction.

7. The welding system according to claim 3, wherein, after distributing the solder paste, the solder paste dispenser is moved outside a field of view of the first camera and the second camera, and the first camera and the second camera capture a set of second images, the solder paste distribution unit includes a solder paste distribution quality inspection device that determines whether the solder paste distribution quality is qualified based on the set of second images.

8. The welding system according to claim 1, further comprising a heating and melting unit, including:
a heating device heating the solder paste that has been distributed onto the pair of micro wires, so as to melt a solder in the solder paste;
a temperature detection device detecting a temperature of the solder paste and an ambient temperature around the solder paste; and
a heating control device controlling a heating temperature and a heating time of the solder paste based on the temperature of the solder paste and the ambient temperature detected by the temperature detection device, until the solder in the solder paste is completely melted.

9. The welding system according to claim 8, wherein the heating and melting unit includes a handling device moving the carrier loaded with the electronic device to a heating zone of the heating device to heat the solder paste distributed on the pair of micro wires of the electronic device.

10. The welding system according to claim 9, wherein, when a distribution quality of the solder paste allocated to the pair of micro wires is qualified, the heating control device controls the handling device to move the carrier to the heating zone of the heating device.

11. The welding system according to claim 10, wherein the handling device is a translation device that can move in three different directions perpendicular to each other, and the carrier is installed on the translation device to be able to move along three different directions with the translation device.

12. The welding system according to claim 10, wherein the handling device is a mechanical arm with a plurality of degrees of freedom, which can grasp the carrier and move the carrier in three different directions perpendicular to each other.

13. The welding system according to claim 10, wherein the temperature detection device includes an infrared camera pointing towards the solder paste on the pair of micro wires to capture a plurality of thermal images of the solder paste and a surrounding environment.

14. The welding system according to claim 13, wherein the heating control device includes an artificial intelligence control network that determines the heating temperature and the heating time of the solder paste based on the thermal images captured by the infrared camera.

15. The welding system according to claim 14, wherein the artificial intelligence control network determines whether the solder in the solder paste has been completely melted based on the thermal images captured by the infrared camera.

16. The welding system according to claim 15, wherein, when the artificial intelligence control network determines that the solder in the solder paste has been completely melted, the artificial intelligence control network controls the handling device to remove the carrier from the heating device to stop heating the solder paste.

17. The welding system according to claim 16, further comprising a welding quality inspection unit checking whether a welding quality of a solder joint that is cured on the pair of micro wires removed from the heating device is qualified.

18. The welding system according to claim 17, wherein the welding quality inspection unit includes:
a visual device including a first camera located above the pair of micro wires and capturing a plurality of images of the solder joint on the pair of micro wires in a vertical direction perpendicular to an axial direction of the pair of micro wires; and
a second camera located in front of a pair of ends of the pair of micro wires and capturing a plurality of images of the solder joint on the pair of micro wires along a horizontal direction parallel to the axial direction of the pair of micro wires; and
a welding quality judgment device which judges whether the welding quality of the solder joint is qualified based on the images of the solder joint from the first camera and the second camera.

19. The welding system according to claim 18, wherein the welding quality judgment device includes an artificial intelligence inspection network, which extracts a plurality of welding joint features from the images of the solder joint and compares the welding joint features with a plurality of pre-learned welding joint features.

20. The welding system according to claim 19, wherein when a similarity between the welding joint features and the pre-learned welding joint features is greater than a predetermined value, the artificial intelligence inspection network determines that the welding quality of the solder joint is qualified.
